(19) United States
(12) Patent Application Publication
(10) Pub. No.: US 2008/0263379 A1
(43) Pub. Date: Oct. 23, 2008

(54) WATCHDOG TIMER DEVICE AND METHODS THEREOF

(75) Inventors: Michael Edward Tuuk, Austin, TX (US); Michael Clark, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: ADVANCED MICRO DEVICES, INC., Sunnyvale, CA (US)

(21) Appl. No.: 11/736,212

(22) Filed: Apr. 17, 2007

(51) Int. Cl. G06F 15/16

(52) U.S. Cl. 713/375

(57) ABSTRACT

To detect a non-responsive condition at a processor, a counter is associated with an operation at a first stage of an instruction pipeline. A value stored in the counter is periodically adjusted towards a threshold value. An error indicator is provided in response to the value stored in the counter reaching the threshold value thereby indicating that a defined amount of time expired before a subsequent stage has completed processing of the operation. However, if the subsequent stage completes processing of the operation prior to the value stored in the counter reaching the threshold, the counter is automatically disassociated with the operation and can, therefore, be associated with another operation at the first stage of the pipeline. Accordingly, the counter does not use an explicit instruction that is responsible for resetting its value.

### FIELD OF THE DISCLOSURE

The present disclosure relates to data processors and more particularly to error detection for data processors.

### BACKGROUND

Some data processors employ watchdog timers to detect an error condition at the processor, such as may result from a problem with a program flow (e.g. a non-exiting loop) at the processor. The watchdog timer continuously counts towards a threshold and if it reaches the threshold an interrupt is typically generated. In response to the interrupt the data processor takes a recovery action to address the error condition, such as initiating a system reset. Accordingly, in order to prevent the watchdog timer from generating the interrupt, the watchdog timer must periodically be serviced. Typically the watchdog timer is serviced by placing explicit instructions into the program flow to reset the timer to assure its periodic reset. However, watchdog timers typically do not provide an indication as to the cause of an error condition. For example, it can be difficult to determine whether a watchdog timer timed out due to an infinite loop in a program flow or due to a stall in an instruction pipeline. In addition, it is difficult for a watchdog timer to detect a stall at an execution unit of an instruction pipeline when other execution units continue to function and are therefore able to service the timer. Accordingly, there is a need for an improved technique for detecting error conditions at a data processor.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of a particular embodiment of data processor;

FIG. 2 is a block diagram of a particular embodiment of a control module of FIG. 1;

FIG. 3 is a block diagram of an alternative particular embodiment of the control module of FIG. 1;

FIG. 4 is a block diagram of a particular embodiment of an instruction pipeline of FIG. 1; and

FIG. 5 is a flow diagram of a particular embodiment of a method of determining a stall at an instruction pipeline.

### DETAILED DESCRIPTION

To detect a non-responsive condition at a processor, a counter is associated with an operation at a first stage of an instruction pipeline. A value stored in the counter is periodically adjusted towards a threshold value. An error indicator is provided in response to the value stored in the counter reaching the threshold value thereby indicating that a defined amount of time expired before a subsequent stage has completed processing of the operation. However, if the subsequent stage completes processing of the operation prior to the value stored in the counter reaching the threshold, the counter is automatically disassociated with the operation and can, therefore, be associated with another operation at the first stage of the pipeline. Accordingly, the counter does not use an explicit instruction that is responsible for resetting its value.

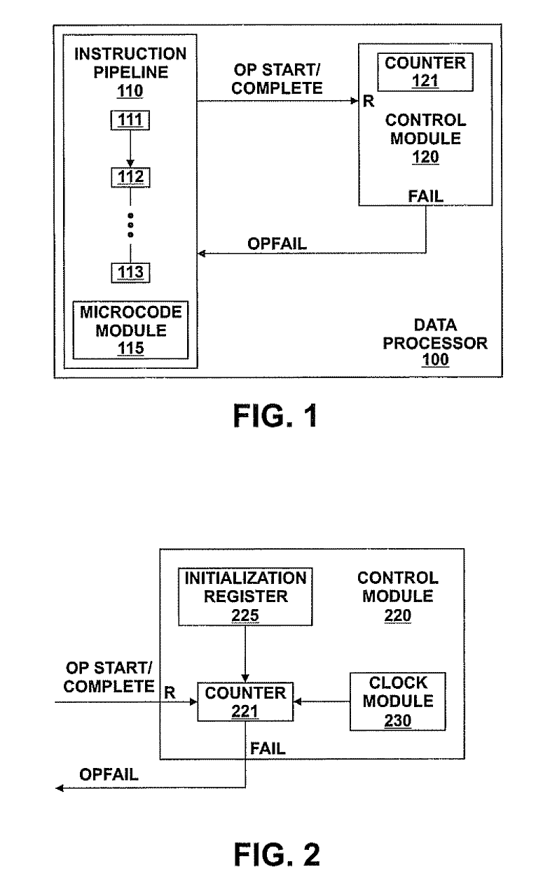

Referring to FIG. 1, a block diagram of a data processor 100 is illustrated. The data processor 100 can be a microprocessor, microcontroller, an application specific integrated circuit (ASIC), and the like. The data processor 100 includes an instruction pipeline 110 and a control module 120. The instruction pipeline 110 includes an output to provide a signal labeled “OP START/COMPLETE” and an input to receive a signal labeled “OPFAIL.” The control module 120 includes an input (R) to receive the OP START/COMPLETE signal and an output (FAIL) to provide the OPFAIL signal. It will be appreciated that although some signals are illustrated with a single line, they can represent multiple signals, such as separate OP START and OP COMPLETE signals.

The instruction pipeline 110 includes a number of pipeline stages including stage 111, stage 112, and additional stages through stage 113. The stage 111 can represent the first stage of the pipeline and the stage 113 can represent the final stage of the pipeline. Alternatively, there may be additional stages before stage 111, and additional stages after stage 113 that are not illustrated. Each stage represents a portion of the instruction pipeline 110 that executes a defined task as part of executing an instruction in a single clock cycle based on an operation that is at the stage for that clock cycle. It will be appreciated that although operations are typically operated on at a stage in a single clock cycle, they can remain at a stage of the instruction pipeline 110 for more than one clock cycle while the processor 100 executes tasks resulting from the operation. For example, an operation can remain at a load/store stage of the instruction pipeline 110 for more than one clock cycle while the processor 100 retrieves data from memory in response to the load/store operation. The instruction pipeline 110 also includes a microcode module 115 which can provide operations to the pipeline for execution.

The control module 120 includes a counter 121 that is configured to be associated with an operation at a specific stage at the instruction pipeline 110 in response to an asserted signal at the R input. In response to assertion of a signal at the R input, the counter 121 is reset. As used herein, the term “reset” means that the value stored by the counter 121 is set to an initialization value or that a new threshold value for comparison to the value stored by the counter 121 is calculated. In addition, the control module 120 is configured to assert a signal at its FAIL output in response to the counter 121 indicating that a defined amount of time has expired, e.g. the threshold value has been reached.

In one embodiment, the control module 120 includes a single counter 121 which is associated with an operation at the instruction pipeline 110 in response to assertion of a signal at the R input. In this case, the control module 120 does not monitor the progress of the operation at the instruction pipeline 110 because the operation is deterministically associated with the counter 121. In another embodiment, the control module 120 can include multiple counters to monitor operations at the instruction pipeline 110, with each counter associated with a different operation. In this case, it may be necessary for the control module 120 to monitor the progress of operations at the instruction pipeline 110, as operations may complete out of order. Accordingly, if a first operation associated with a first counter completes, asserting the OP COMPLETE signal, the control module can determine which of the counters should be reset.

During operation, the instruction pipeline 110 executes operations based on instructions being executed at the data processor 100. The operations are advanced stage by stage through the instruction pipeline 110. In response to an operation reaching the stage 112, the OP START/COMPLETE signal is asserted, thereby resetting the counter 121 and associating it with the operation at the stage 112. In a particular embodiment, the value stored in the counter 121 is adjusted (e.g. incremented or decremented) over time towards a threshold value, such that it is an indicator that a defined amount of time has elapsed since the operation began execution at the stage 112 if the value stored by the counter 121 reaches the threshold. In a particular embodiment, the defined amount of time is programmable. In another embodiment, the defined amount of time is predefined.

In response to the value stored at the counter 121 reaching the threshold value, the control module 120 asserts the OPFAIL signal to indicate that the operation did not reach an expected stage, such as stage 113, prior to the threshold value being reached, i.e., a defined amount of time elapsing. This can be indicative of an error condition at the instruction pipeline 110. The assertion of the OPFAIL signal causes the instruction pipeline 110 to simulate completion of the operation. In a particular embodiment, the instruction pipeline 110 simulates completion of the operation by indicating an exception at the pipeline, thereby causing operations to be flushed from one or more of the stages 111-113. In addition, in response to assertion of the OPFAIL signal the instruction pipeline 110 executes a debug procedure by instructing the microcode module 115 to provide debug code to one or more of the stages 111-113 for execution. The debug code can perform a machine check to retrieve state information from the instruction pipeline 110 that can be analyzed to determine which operation resulted in the stall.

In response to a stage of the instruction pipeline 110, such as the stage 113, completing processing of the operation prior to assertion of the OPFAIL signal, the instruction pipeline 110 asserts the OP START/COMPLETE signal to de-associate the counter 121 with the completed operation. In one embodiment, the OP START/COMPLETE signal is subsequently asserted to associate another operation at stage 112 with the counter 121. In another embodiment, when the OP START/COMPLETE signal is asserted to indicate completion of an operation, another operation at the instruction pipeline 110 is immediately and automatically associated with the counter 121.

Referring to FIG. 2, a block diagram of a particular embodiment of a control module 220, corresponding to the control module 120 of FIG. 1, is illustrated. The control module 220 includes a counter 221, an initialization register 225, and a clock module 230. The initialization register 225 stores a value used to initialize the counter 221, and includes an output to provide the initialization value to the counter 221. The counter 221 includes an input connected to the R input and, in response to an asserted signal at the R input, loads the initialization value provided by the initialization register 225.

The clock module 230 includes an output to provide a clock signal to adjust a value stored at the counter 221. The clock signal can be a periodic signal or non periodic signal, such as a system clock, a real time clock, and the like. It will be appreciated that the clock signal can also be received by the control module 220 from an external source rather than generated internally at the clock module 230. In addition, the clock module 230 could receive the external clock signal and modify the received signal to provide the clock signal to the counter 221.

During operation, the OP START/COMPLETE signal at the R input is asserted to associate the counter 221 with an operation at a stage of the instruction pipeline 110 (FIG. 1). In response, the initialization value stored at the initialization register 225 is loaded into the counter 221. In one embodiment, the value stored in the counter 221 is decremented based on the clock signal provided by the clock module 230. When the value stored by the counter reaches zero, the counter 220 asserts the OPFAIL signal to indicate that a defined amount of time has elapsed since the operation associated with the counter 221 began execution at a stage of the instruction pipeline 110. Assertion of the OPFAIL signal thus indicates that the operation associated with the counter 221 did no complete within an expected amount of time.

If the OP START/COMPLETE signal at the R input is asserted prior to assertion of the OPFAIL signal, indicating that the operation associated with the counter 221 has completed operation at a stage of the instruction pipeline 110, the threshold value stored in the threshold register 225 is again loaded into the counter 221. This prevents an assertion of the OPFAIL signal for the completed operation and associates the counter 221 with another operation at the instruction pipeline 110. Accordingly, as operations associated with the counter 221 are completed at the instruction pipeline 110, the operation is disassociated with the counter 221, and the counter 221 can be subsequently be associated with other operations at other stages of the pipeline. In one embodiment, the counter 221 is automatically associated with another operation at the counter in response to an assertion of the OP START/COMPLETE signal that indicates an operation has completed processing at a stage of the instruction pipeline 110. In another embodiment, the assertion of the OP START/COMPLETE signal to indicate that the operation has been completed disassociates the counter 221 with the completed operation, but does not associated the counter 221 with another operation. In this case the counter 221 may not be reset, but adjustment of the counter can be stopped so that the counter 221 does not assert the OPFAIL signal. A subsequent assertion of the OP START/COMPLETE signal to indicate that a new operation has reached a particular stage of the instruction pipeline 110 associates the counter 221 with the operation by resetting the counter 221.

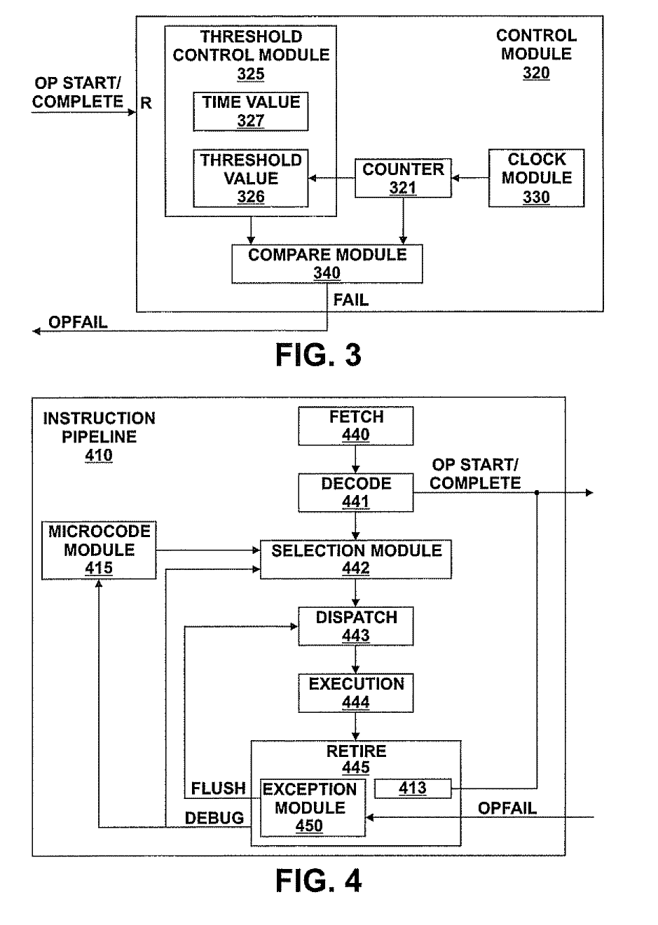

Referring to FIG. 3, a block diagram of an alternative embodiment of a control module 320 using a free-running counter 321, corresponding to control module 120 of FIG. 1, is illustrated. The control module 320 includes the counter 321, a threshold control module 325, a clock module 330, and a compare module 340. The clock module 330 includes an output to provide a clock signal. The counter 321 includes an input coupled to the output of the clock module 330, a first output, and a second output. The threshold control module 325 includes an input connected to the R input of the control module 320, an input connected to the first output of the counter 321, and an output. The compare module 340 includes an input connected to the output of the threshold control module 325, an output connected to the second output of the counter 321, and an output connected to the output FAIL of the control module 320 to provide the OPFAIL signal.

The counter 321 is a free-running counter that stores a value that is adjusted based on a clock signal provided by the clock module 330. The clock signal can be a periodic signal based on a system clock, a periodic signal based on a real time clock, a signal based on the timing of system events, and the like.

The threshold control module 325 includes a register 327 that stores a time value representing a defined amount of time. The register 327 can be user programmable and can store a value that is expressed in clock cycles of the clock signal provided by the clock module 330. The threshold control module 325 also includes a register 326 to store a threshold value.

During operation, in response to an assertion of the OP START/COMPLETE signal at the R input to indicate that the counter 321 should be associated with an operation, the threshold control module 325 calculates a threshold value based on the time value stored in the register 327 and on the value stored at the counter 321 when the OP START/COMPLETE signal is asserted. For example, the threshold control module 325 can add the time value 327 to the value stored in the counter 321 to determine the threshold value. Calculation of the threshold value thus associates the counter 321 with an operation at the instruction pipeline 110 (FIG. 1) that caused assertion of the OP START/COMPLETE signal. The threshold control module 325 stores the threshold value in the register 326.

The compare module 340 compares the value stored at the counter 321 to the threshold value stored in the register 326. If the values match, indicating that the defined amount of time represented by the time value stored in the register 327 has elapsed, the compare module 340 asserts the OPFAIL signal, thereby indicating an error condition.

If the OP START/COMPLETE signal is asserted to indicate completion of an operation at a stage of the instruction pipeline 110 prior to a match being indicated by the compare module 340, the threshold control module 325 calculates a new threshold value and stores it at the register 326. This prevents assertion of the OPFAIL signal for the completed operation.

Referring to FIG. 4, a block diagram of a particular embodiment of an instruction pipeline 410, corresponding to the instruction pipeline 110 of FIG. 1, is illustrated. The instruction pipeline 110 includes a fetch portion 440, a decode portion 441, a selection module 442, a dispatch portion 443, an execution portion 444, and a retire portion 445. The instruction pipeline also includes a microcode module 415.

During operation, the instruction pipeline 410 executes instructions in a pipelined fashion at each stage of the portions 440-445. The fetch portion 440 fetches instruction data from an instruction cache (not shown) and provides the instruction data to the decode portion 441. The instruction data represents instructions of a program flow. The decode portion 441 decodes the instruction data to identify individual instructions and to determine one or more operations associated with each individual instruction. These operations are provided to the selection module 442. The selection module 442 receives operations from the decode portion 441 and from the microcode module 415 and based on control signals such as the signal DEBUG determines which operations are provided to the dispatch portion 443.

The dispatch portion 443 provides the received operations to an execution unit (not shown) of the execution portion 444. The execution unit of the execution portion 444 executes the instruction, and provides the instruction to the retire portion 445. The retire portion 445 uses an exception module to determine if the operation has resulted in an exception, such as mispredicted branch. If an exception is determined, the retire portion 445 can take actions to remedy the exception, such as asserting the FLUSH signal to flush operations from the instruction pipeline 410.

When a first operation reaches a particular stage of the decode portion 441, the operation is available to be associated with the counter 121 (FIG. 1) as previously discussed. To associate the operation with the counter 121, the instruction pipeline 410 asserts the OP START/COMPLETE signal. The retire portion 445 includes a stage 413. In response to an operation completing processing at the stage 413, the retire portion 445 asserts the OP START/COMPLETE signal, which disassociates the operation in the instruction pipeline 410 with the counter 121. In a particular embodiment, this automatically associates another operation at the instruction pipeline 410 with the counter 121. In another embodiment, another operation is not associated with the counter 121 until a subsequent assertion of the OP START/COMPLETE signal to indicate that the operation should be associated.

If the OPFAIL signal is asserted by the control module 120 (FIG. 1) prior to the operation associated with the counter 121 completing processing at the stage 413, indicating an error condition, an exception is indicated by the exception module 450. In particular, the exception module 450 asserts the FLUSH signal, thereby clearing the dispatch portion 443 of operations.

In addition, in response to the OPFAIL signal, the exception module 450 asserts the DEBUG signal. This causes the microcode module 415 to provide debug operations to the selection module 442. Based on the asserted DEBUG signal, the selection module 442 provides the debug code to the dispatch portion 443 so that the debug code can be executed at the execution portion 444. Accordingly, the error condition at the data processor 102 automatically results in execution of the debug operations. The debug operations can execute tasks to allow the instruction pipeline 410 to be analyzed and the cause of the error condition state to be determined.

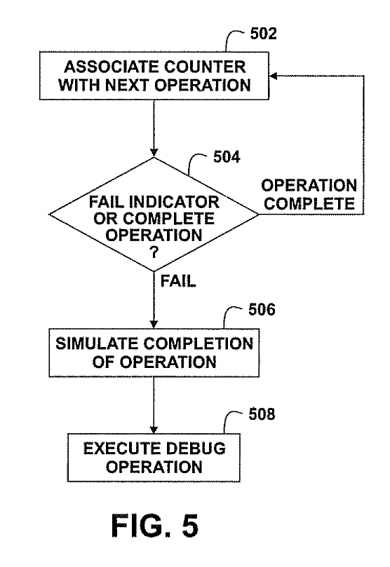

Referring to FIG. 5, a flow diagram of a particular embodiment of a method of detecting a stall at an instruction pipeline is illustrated. At block 502, a counter of the control module is associated with an operation in an instruction pipeline at a data processor. Associating the control module with an operation can include resetting the counter by setting the counter to an initialization value or by calculating a threshold to represent a defined amount of time based on the contents of the counter.

At decision block 504, it is determined whether a fail indicator is received prior to a stage of the instruction pipeline completing processing of the operation. If the processing of the operation is complete before a fail indicator is received, the method flow returns to block 502, the control module is again set. The counter is therefore available for association with another operation.

If, a fail indicator is received, this indicates an error condition at the data processor, e.g. an operation has not been completed at a specific stage of an instruction pipeline. In a particular embodiment, the fail indicator is received in response to the value at the counter indicating that a defined amount of time since the counter was set. In response to the fail indicator, the method flow moves to block 506 and the instruction pipeline simulates completion of the operation that was associated with the counter at block 502. The method flow moves to block 508 and a debug operation is executed at the instruction pipeline.

Other embodiments, uses, and advantages of the disclosure will be apparent to those skilled in the art from consideration of the specification and practice of the disclosure disclosed herein. For example, it will be appreciated that although it has been described herein that a counter is associated with an operation by resetting the counter when the operation reaches a particular stage of an instruction pipeline, the operation could be associated with the operation when it reaches a first stage of the instruction pipeline, and the counter reset in response to the operation reaching a second stage of the instruction pipeline. It addition, it will be appreciated that the stage which associates an operation with the counter, and the stage which resets the counter, can each be programmable. Similarly, the stage that disassociates the operation with the counter can be programmable. It will further be appreciated that, although some circuit elements and modules are depicted and described as connected to other circuit elements, the illustrated elements may also be coupled via additional circuit elements, such as resistors, capacitors, transistors, and the like. The specification and drawings should be considered exemplary only, and the scope of the disclosure is accordingly intended to be limited only by the following claims and equivalents thereof.

What is claimed is:

1. A method, comprising:
associating a first operation at a first stage of an instruction pipeline of a data processor with a first counter to reset the first counter;
periodically adjusting a value stored at the first counter; and
providing an error indicator in response to the value stored at the first counter indicating a defined amount of time has been exceeded prior to a second stage of the instruction pipeline completing processing of the first operation.

2. The method of claim 1, further comprising automatically associating the first counter with a second operation at the first stage of the instruction pipeline in response to the second stage of the instruction pipeline completing processing of the first operation prior to the first counter indicating the defined amount of time has been exceeded.

3. The method of claim 2, wherein the second stage of the instruction pipeline is a retire stage.

4. The method of claim 1, wherein the first counter is reset while the first operation is at the first stage.

5. The method of claim 1, further comprising simulating completion of the first operation in an instruction pipeline in response to the error indicator.

6. The method of claim 1, further comprising executing a debug operation in response to the error indicator.

7. The method of claim 1, wherein associating the first counter with the first operation comprises determining an expected value of the first counter at a future time.

8. A method, comprising:
setting a control module to provide an indicator in response to determining a first amount of time has elapsed during execution of a first operation at an instruction pipeline of a data processor based upon a first value stored at a first counter;
periodically adjusting the first value; and
in response to receiving the indicator prior to a first portion of the instruction pipeline completing processing of the first operation, executing a debug operation.

9. The method of claim 8, further comprising:
in response to completing processing of the operation at the first portion of the instruction pipeline prior to receiving the indicator, setting the control module to provide the indicator in response to determining a second amount of time has elapsed during execution of a second operation at the instruction pipeline of a data processor based upon second value stored at the first counter.

10. The method of claim 9, wherein the first operation and the second operation are associated with a first instruction.

11. The method of claim 8, wherein the first portion of the instruction pipeline is a retirement portion.

12. The method of claim 8, wherein executing the debug operation comprises simulating completion of the operation in an instruction pipeline.

13. The method of claim 12, wherein executing the debug operation further comprises flushing a second portion of the instruction pipeline in response to simulated completion of the operation.

14. The method of claim 13, wherein the second portion of the instruction pipeline is a dispatch portion.

15. The method of claim 8, wherein executing the debug operation comprises providing a plurality of debug operations to a portion of the instruction pipeline.

16. The method of claim 8, wherein executing the debug operation comprises executing a machine check operation.

17. The method of claim 8, wherein the first amount of time is programmable.

18. The method of claim 8, wherein the first amount of time is based on a predefined amount of time.

19. A device, comprising:
an instruction pipeline comprising a plurality of stages, an input, and an output to provide a completion indicator in response to a first of the plurality of stages of the instruction pipeline completing processing of a first of a plurality of operations; and
a control module comprising:
a counter associated with the first of the plurality of operations;
an input coupled to the output of the instruction pipeline, the input configured to associate the counter with a second of the plurality of operations in response to the instruction pipeline providing the completion indicator; and
an output coupled to the input of the instruction pipeline, the output configured to provide an error indicator in response to the counter indicating a defined amount of time has been exceeded prior to the instruction pipeline providing the first indicator.
